(19) United States
(12) Patent Application Publication
(10) Pub. No.: US 2007/0235375 A1
(43) Pub. Date: Oct. 11, 2007

(54) Filter with combination valve having elongated openings in the end plate

(76) Inventors: Kent C. Stanhope, Albion, IL (US); Kris Stanhope, Browns, IL (US); John A. Ivy, Olney, IL (US); John D. Gaither, West Salem, IL (US)

Correspondence Address: OLSON & HIERL, LTD., 20 NORTH WACKER DRIVE, 36TH FLOOR, CHICAGO, IL, 60606, US

(21) Appl. No.: 11/401,586

(22) Filed: Apr. 11, 2006

(51) Int. Cl. B01D 35/14

(52) U.S. Cl. 210/130; 210/424; 210/433.1; 210/450

(57) ABSTRACT

A filter assembly having a housing open at one end, and an annular filter element disposed in the housing. An end plate having elongated openings and auxiliary openings are arranged in a generally circular configuration radially equidistant from the center of the end plate. An outlet opening is disposed in the open end of the housing. The end plate is affixed to a lid which is secured to the end of the housing. A combination valve is retained between the annular filter element and the end plate. The combination valve includes an annular shoulder subdividing the elongated openings into inlet opening portions and bypass opening portions. The combination valve has a first portion that cooperates with the inlet opening portions in the end plate and a second portion that cooperates with the bypass opening portions. The second portion has more resistance to fluid flow than the first portion.

### A. FIELD OF THE INVENTION

This invention pertains to a fluid filter assembly having a combination valve retained between an annular filter element and an end plate, the combination valve cooperating with the end plate for controlling fluid flow through the fluid filter.

### B. DESCRIPTION OF RELATED ART

Prior art filters such as that shown in U.S. Pat. No. 6,595,372 to Minowa et al include a filter device having a housing with an open end, a filter element received in the housing, an end plate closing the open end and having inlet and outlet openings therein, and a valve for cooperating with the inlet openings to allow oil to flow into the filter through the inlet openings, but prevent the flow of oil in a reverse direction.

Still other prior art filters are known, such as U.S. Pat. No. 5,405,527 to Covington, that include a combination valve with two portions, the first for closing the inlet openings to block the flow of oil back out of the inlet openings when the oil is not being circulated and the second portion for opening a bypass opening when the filter element is clogged for returning oil to the engine to keep the engine lubricated even though the filter element is clogged.

The present invention improves upon the filter with a combination valve and overcomes the disadvantages and deficiencies of such prior art constructions as described herein.

### C. SUMMARY OF THE INVENTION

An object of the present invention is to provide an improved fluid filter assembly that has a simpler design than prior art fluid filter assemblies.

The invention pertains to a fluid filter assembly having a housing open at one end, with an annular filter element having a first end and a second end disposed in the housing. An end plate having elongated or slotted opening means and outlet opening means is secured to the open end of the housing. The end plate may further include auxiliary openings. The elongated opening means and the auxiliary openings are disposed on the end plate so that the elongated opening means and the auxiliary openings are substantially equidistant from the center of the end plate.

A combination valve is disposed between the first end of the annular filter element and the end plate for controlling fluid flow through the elongated opening means. The combination valve has a shoulder that subdivides the elongated opening means and defines an inlet opening portion and a bypass opening portion. The combination valve further includes a first portion cooperating with the inlet opening portion and the auxiliary openings and a second portion cooperating with the bypass opening portion. In normal operation, the first portion of the combination valve will yield before the second portion of the combination valve. Fluid thus flows through the inlet opening portion and the auxiliary openings, through the annular filter element before being discharged through the outlet opening means. When the annular element begins to clog, fluid pressure builds to a predetermined pressure, causing the second portion of the combination valve cooperating with the bypass opening portion to open. Fluid then flows through the bypass opening portion and out the outlet opening means, thereby bypassing the annular filter element.

A spring is disposed between the second end of the annular filter element and the housing. The spring biases the annular filter element towards the end plate to retain the combination valve in place. A seal is thus formed to prevent fluid flow from between the combination valve and the annular filter element and from between the combination valve and the end plate.

### D. BRIEF DESCRIPTION OF THE DRAWINGS

There is shown in the attached drawings a presently preferred embodiment of the present invention, wherein like numerals in the various views refer to like elements and wherein:

FIG. 1 is a side view of the filter assembly of the present invention, with part of the filter housing cut away to show interior parts including the combination valve;

FIG. 2 is a bottom view of the end plate;

FIG. 3 is a cross-sectional view of the end plate of FIG. 2 taken generally along the line 3-3; and

FIG. 4 is a cross sectional view of the combination valve of FIG. 1.

### E. DETAILED DESCRIPTION OF THE INVENTION

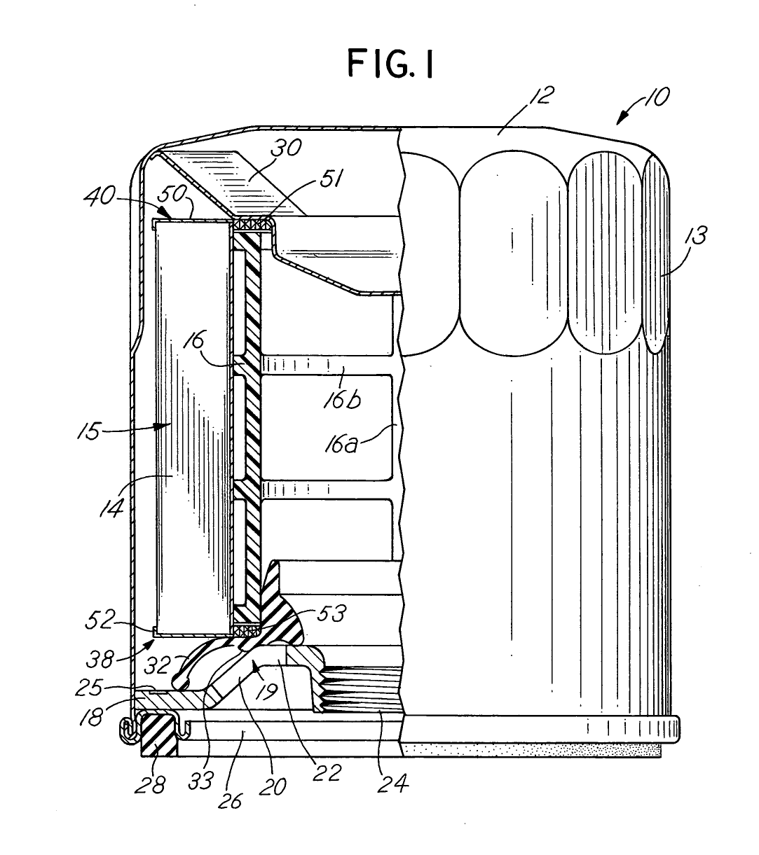

There is shown in FIG. 1 a filter assembly embodying the present invention. The filter assembly 10 includes a generally cylindrical shell or housing 12 that is generally cup shaped and open on one end and closed on the other. Recesses or flutes 13 may be provided in the surface of the housing 12 proximate the closed end. The flutes 13 will provide a gripping surface to enhance installation of a filter assembly 10 on an engine (not shown). Disposed within the housing 12 is an annular filter media 14 that is mounted on a core 16. The annular filter media 14 and the core 16 form an annular filter element 15. The filter media 14 may be a conventional pleated filter media comprised, for example, of cellulose or cellulose with some polyester. The core 16, which may be molded from an appropriate material, for example, a glass filled plastic such as Nylon, is perforated so as to permit fluid flow there through in use. Essentially, the core 16 comprises a cage formed by vertically disposed members 16a suitably secured to horizontally disposed members 16b. The filter media 14 may be formed from a sheet of pleated material joined along the facing ends by a suitable adhesive to form an annular sleeve on the core 16.

End caps 50 and 52 are disposed at the first end 38 and the second end 40 of the annular filter element. End caps 50 and 52 may be fabricated from a composite material such as cellulose/polyester composite and are preferably, thermally bonded, e.g., ultrasonically welded to the filter media 14.

An end plate 18 is secured to the housing 12 and closes the open end of housing 12. The end plate 18 has a plurality of elongated or slotted opening means 19 for permitting fluid flow into filter assembly 10 and outlet opening means 24 for permitting fluid flow out of the filter assembly 10. The elongated opening means 19 comprises one or more, discrete elongated openings or slot-like openings. The outlet opening means 24 may comprise one central discrete opening.

The elongated opening means 19 are preferably a plurality of discrete elongated openings arranged circumferentially about a central axis of the filter (or circumferentially arranged about the outlet opening 24). Advantage is obtained in that the longer elongated openings 19 are easier to manufacture than smaller openings. The elongated openings 19 serve a dual purpose role as both inlet openings and bypass openings when used in conjunction with the combination valve 32 as described herein. By reducing the overall number of holes from a set of inlet openings and a second set of bypass openings, the overall structural integrity of the end plate 18 is enhanced.

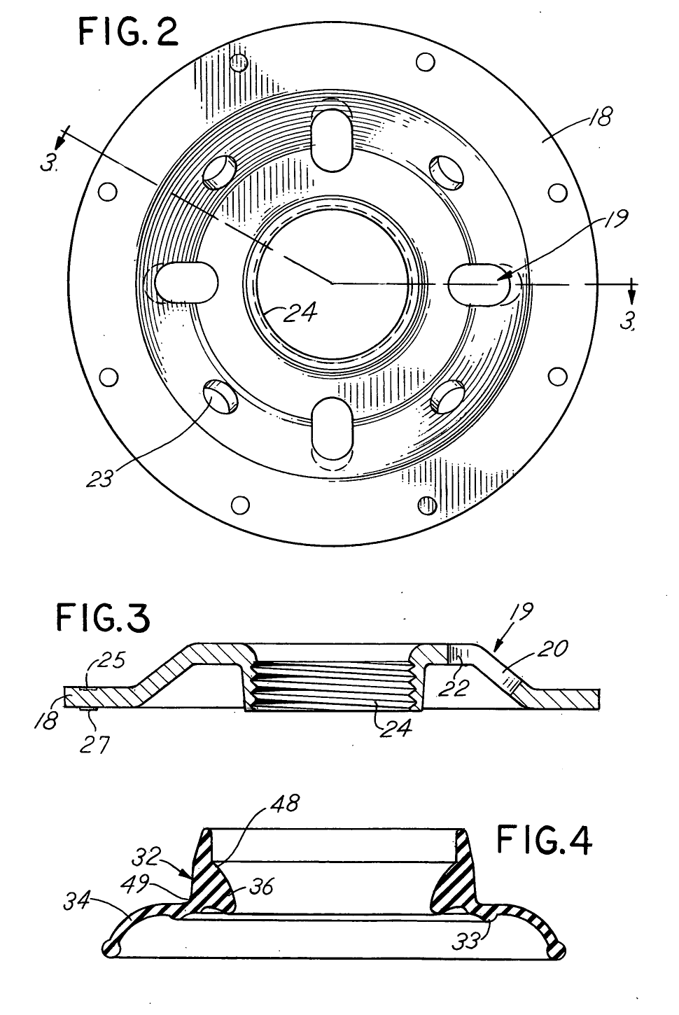

A lid 26 is secured to end plate 18. As best seen in FIG. 3, recesses or depressions 25 are formed on the top surface of the end plate 18 and complementary projections 27 are formed in the opposite or bottom surface of the end plate as viewed in FIG. 3. The projections 27 facilitate fastening of the lid 26 to the end plate 18, e.g., by welding. The recesses and depressions 25, 27 are arranged in a circle spaced radially outward from the central axis of the outlet opening 24, as best seen in FIG. 2. An annular resilient gasket 28 is received and retained in a recess in lid 26 for providing a seal between the filter assembly 10 and the engine block (not shown) to which the filter assembly 10 is secured in normal use.

On the closed end of the housing 12, resilient means, such as spring 30 is disposed between the closed end of housing 12 and the second end 40 of the annular filter element. Spring 30 biases the annular filter element towards the end plate 18 and the lid 26.

Disposed near the open end of housing 12 between the annular filter element and the end plate 18 is a combination valve 32. The combination valve 32, which is retained between the first end 38 of the annular filter element and the end plate 18 by the biasing force of spring 30. Fluid flow between the combination valve 32 and the annular filter element is prevented by the sealing engagement of the combination valve 32 and the first end 38 of the annular filter element. Fluid flow is also blocked by the sealing arrangement of the combination valve 32 and the end plate 18. Sealing means 51, 53 in the form of gaskets may be provided at the ends of the core 16 to help seal the ends of the filter element 15 with respect to the spring 30 and the combination valve 32, respectively.

FIG. 2 shows the bottom view of the filter assembly 10 and better demonstrates the configuration of the elongated openings 19 and the auxiliary openings 23 on the end plate 18. In the presently preferred embodiment, end plate 18 includes four elongated openings 19 and four auxiliary openings 23. Elongated openings 19 and auxiliary openings 23 are arranged in an alternating pattern circumferentially equidistant from the central axis of the filter assembly 10. This configuration of elongated openings 19 and auxiliary openings 23 in a substantially radially equidistant configuration simplifies manufacturing of the end plate 18. The auxiliary openings 23 can be omitted, if the elongated openings 19 are constructed and arranged to permit sufficient fluid flow through the filter assembly 10 for the desired application. Opening configurations for auxiliary openings 23 other than round are feasible and the number of openings can be varied to accommodate the desired fluid flow for the desired application for the filter assembly 10.

As shown in FIG. 3, the end plate 18 also includes an outlet opening 24 from which fluid flows out of the filter assembly 10. The outlet opening 24 may be threaded to facilitate engagement of the filter assembly 10 with the engine (not shown).

The combination valve 32 is shown in FIG. 4. The combination valve 32, which is generally annular and is fabricated from a resilient material, such as synthetic rubber, is disposed to control fluid flow through elongated opening means 19 and the auxiliary openings 23. The combination valve 32 includes an annular shoulder or protrusion portion 33 that subdivides each of the elongated openings 19 into an inlet opening portion 20 and a bypass opening portion 22. The combination valve 32 further includes a first portion 34 for controlling fluid flow through the inlet opening portion 20 of the elongated opening 19 as well as auxiliary openings 23 and a second portion 36 for controlling fluid flow through the bypass opening portion 22 of the elongated opening 19. The combination valve 32 also has a central portion 48 that extends upwardly and cooperates with the horizontal part of the first portion 34 to form a shoulder 49 against which the annular filter element 15 firmly engages to seal fluid flow between the annular filter element 15 and the combination valve 32.

The first portion 34 of the combination valve 32 is annular and has a bend intermediate the radial extent of the first portion 34. As seen in FIG. 4, the part of the first portion 34 that engages the second portion 36 extends generally horizontally and the free end of the first portion 34 is inclined outwardly and downwardly from the horizontal position. The second portion 36 includes an annular inwardly inclined part adapted to cooperate with the bypass opening portion 22.

The combination valve 32 is constructed and arranged so that the first portion 34 is more resilient than the second portion 36. One way to accomplish this is by the relative thickness of the first portion 34 and the second portion 36. The first portion 34 can be thinner and hence more flexible than the second portion 36. In this way, the first portion 34 will open under a lesser pressure, whereas the second portion 36 is stiffer and requires a higher pressure to open. Auxiliary openings 23 are optional but may be included for providing extra fluid flow paths to reduce pressure building from fluid flow restrictions. In a presently preferred embodiment, the first valve 34 will open to permit fluid flow through the inlet opening portion 20 of the elongated openings 19 and the auxiliary openings 23 at a minimum pressure, for example on the order of 1 psi. By comparison, the second valve 36 will open to permit fluid flow through the bypass opening portions 22 of the elongated openings 19 at a higher predetermined pressure, for example on the order of 8-10 psi.

The assembly of the filter assembly 10 will now be described. The annular filter media 14 is positioned on the core 16 and the end caps 50 and 52 are positioned over the ends of the filter media and secured together in assembled relationship to form the annular filter element 15.

The end plate 18 and the lid 26 are secured together, for example, by welding, and the resilient gasket 28 is positioned and retained in the recess of the lid 26. Spring 30 is first inserted into the open end of the housing 12 until it seats against the closed end of the housing 12. The second end 40 of the annular filter element 15 is positioned in sealing engagement with the spring 30.

Combination valve 32 is firmly seated against the first end 38 of the annular filter element to create a fluid-tight seal between the annular filter element 15 and the combination valve 32. The end plate 18 closes the open end of housing 12 and is positioned so that the shoulder 33 of the combination valve 32 subdivides the elongated openings 19 into inlet opening portions 20 and bypass opening portions 22. The first portion 34 of the combination valve 32 cooperates with the inlet opening portions 20 and auxiliary openings 23 on the end plate 18 and the second portion 36 of the combination valve 32 cooperates with the bypass opening portions 22 of the subdivided elongated or slotted openings 19. The end plate 18 and the outer rim of the lid 26 are rolled with the open end of the housing 12 to form a seal as shown in FIG. 1.

Positioning of the end plate 18 in the housing 12 partially compresses the spring 30, whereby, when the parts are assembled a biasing force is applied by the spring 30 to the top of the annular filter element 15, urging the annular filter element 15, towards the end plate 18. The spring force will help to pin the combination valve 32 between the annular filter element 15, and the end plate 18 and to seal flow from between the annular filter element 15 and combination valve 32, as well as between the annular filter element 15, and the end plate 18.

In operation, the filter assembly 10 is spun onto a threaded stud on the engine block which engages the threads in the outlet opening 24 in the end plate 18 and is secured in place. The flutes or recesses 13 in the housing 12 may be engaged by a tool to help to rotate the housing 12 firmly onto the threaded stud on the engine block in a conventional manner. The resilient gasket 28 will engage the engine block and preclude fluid flow from between the engine block and the filter assembly 10. When the engine is started, fluid, usually oil, will enter the filter assembly 10 through inlet opening portions 20 of elongated openings 19 and the auxiliary openings 23. Slight pressure will move the first portion 34 of the combination valve 32 away from the inlet opening portions 20 and auxiliary openings 23 to open same and oil will flow through inlet opening portions 20 and auxiliary openings 23, the filter media 14 and be discharged through the outlet opening means 24 for return to the engine. When the engine is turned off, the first portion 34 of combination valve 32 serves as an anti-drain valve, closing fluid flow through the inlet opening portions 20 and the auxiliary openings 23 to prevent the return of oil in the filter assembly 10 to the engine.

As the filter media 14 clogs during normal operation, pressure will build within the housing 12 of the filter assembly 10. Upon attainment of a predetermined pressure, the second portion 36 of combination valve 32 will open and permit oil to flow through the radially proximal part of bypass opening portions 22 of the elongated openings 19. Oil thus flows through bypass opening portions 22 and through outlet opening means 24 and back to the engine, thereby bypassing the filter media 14. Stated somewhat differently, during periods of time when high differential pressure exists across the filter media 14, such as due to cold thick oil or high contaminant loading of the filter media, the oil will go through the bypass openings portions 22 and open the second valve 36 to permit oil to bypass the filter media 14 and exit the filter assembly 10 through the outlet opening 24 for return to the engine.

The elongated openings 19 which include inlet opening portion 20 and bypass opening portions 22 simplify construction of the end plate 18. The combination valve 32 uniquely cooperates with the end plate 18 to divide the elongated or slotted openings 19 into the discrete inlet opening portions 20 and by pass opening portions 22.

While a presently preferred embodiment of the present invention has been shown and described, it will be apparent to persons skilled in the art that the invention may be otherwise embodied within the scope of the following claims.

We claim:

1. A filter assembly comprising:
a housing open at one end,
an annular filter element disposed in said housing, the annular filter element further comprising a first end and a second end;
an end plate secured to the open end of the housing, the end plate further having a plurality of elongated opening means and outlet opening means, the elongated opening means further being disposed substantially equidistant from the center of the end plate;
a combination valve disposed between the first end of the annular filter element and the end plate for controlling fluid flow through the elongated opening means, the combination valve comprising an annular shoulder that subdivides the elongated opening means into an inlet opening portion and a bypass opening portion, the combination valve further including a first portion cooperating with the inlet opening portion and a second portion cooperating with the bypass opening portion, the second portion having more resistance to fluid flow than the first portion;
and biasing means in the housing for urging the first end of the annular filter element into sealing relationship with the combination valve;
whereby, in normal operation, the first portion of the combination valve will yield before the second portion of the combination valve and fluid flow will pass through the inlet opening portion, the annular filter element and then be discharged through the outlet opening means, and
whereby when the annular filter element begins to clog, fluid pressure will build and upon attainment of a predetermined pressure, the second portion of the combination valve will open the bypass opening portion and permit fluid flow to bypass the annular filter element through the bypass opening portion and out the outlet opening means.

2. The filter assembly of claim 1 wherein the elongated opening means comprises at least one discrete elongated opening.

3. The filter assembly of claim 1 wherein the end plate further comprises a plurality of auxiliary openings cooperating with the first portion of the combination valve to reduce flow restriction.

4. The filter assembly of claim 3 wherein the end plate includes four elongated openings and four auxiliary openings.

5. The filter assembly of claim 3 wherein the auxiliary openings are arranged generally circumferentially around the axis of the annular filter element.

6. The filter assembly of claim 1, wherein the biasing means comprises a spring that biases the annular filter element towards the end plate to retain the combination valve in place.

7. The filter assembly of claim 6 wherein the annular filter element further comprises a central core surrounded by filter media and the lower end of the central core engages the central portion of the combination valve.

8. The filter assembly of claim 1 wherein the combination valve comprises an annular member, with the first portion extending outwardly from a central portion and the second portion extending inwardly from the central portion, the second portion being stiffer than the first portion; the annular filter element engaging the central portion of the combination valve between the first portion and the second portion to retain the combination valve in place.

9. The filter assembly of claim 1 wherein the elongated opening means comprises a plurality of elongated openings arranged generally circumferentially around the axis of the filter element.

10. The filter assembly of claim 1 wherein the elongated opening means comprise a plurality of elongated openings and the end plate further comprising a plurality of auxiliary openings cooperating with the first portion of the combination valve, the elongated openings and the auxiliary openings further being arranged in an alternating fashion generally circumferentially around the axis of the filter element.

11. In a fluid filter comprising a housing open at one end, an annular filter element in said housing, and an end plate at the open end of the housing for retaining the filter element in the housing, said end plate including an outlet opening, the improvement comprising the end plate having at least one flow opening and an annular combination valve disposed between the filter element and the end plate, the combination valve including an annular shoulder cooperating with the flow opening for subdividing same into an inlet opening and a bypass opening, the combination valve including a first portion cooperating with the inlet opening and a second portion cooperating with the bypass opening, the second portion having more resistance to fluid flow than the first portion, whereby in normal operation, the first portion will yield before the second portion of the combination valve and fluid flow will pass through the inlet opening, the annular filter element and then be discharged through the outlet opening, and whereby when the annular filter element experiences conditions of high differential pressure the combination valve will open the bypass opening and permit fluid flow to bypass the annular filter element through the bypass opening and out the outlet opening.

12. The fluid filter of claim 11, wherein there are a plurality of flow openings in the end plate, each of which is elongated, and each of which is divided by the annular shoulder of the combination valve into an inlet opening and a bypass opening.

13. The fluid filter of claim 12, including a plurality of auxiliary openings in the end plate, the first portion of the combination valve operating with both the inlet openings and the auxiliary openings.
